(19) United States
(12) Patent Application Publication
(10) Pub. No.: US 2011/0184949 A1
(43) Pub. Date: Jul. 28, 2011

(54) RECOMMENDING PLACES TO VISIT

(76) Inventor: Jiebo Luo, Pittsford, NY (US)

(21) Appl. No.: 12/692,815

(22) Filed: Jan. 25, 2010

(51) Int. Cl. G06F 17/30

(52) U.S. Cl. 707/737; 707/E17.046

(57) ABSTRACT

A method for recommending places to visit, included using a processor to provide the following steps: assembling a collection of images, wherein each image has first and second tags with the first tag corresponding to the location where the image was taken, and the second tag corresponding to subject matter of the image; clustering the images in response to the first tags into a plurality of locations; using the images in each location to produce at least one representative image of the location; using the second tags of images of each location to produce a list of representative keywords for each location; providing a query in the form of an image or subject matter, or both; and using the query in the form of an image to search among the representative images to recommend a location to visit, or using the query in the form of subject matter to search among the keywords to recommend a location to visit.

### FIELD OF THE INVENTION

The present invention relates to recommending places to visit, particularly utilizing tagged images on the web to respond to a user query in the form of either keywords or example images.

### BACKGROUND OF THE INVENTION

In recent years, the popularity of digital cameras has lead to a flourish of personal digital photos. For example, Kodak Gallery, Flickr and Picasa Web Album host millions of new personal photos uploaded every month. Many of these images were photos taken when people visited various interesting places around the world. Moreover, many of these photos have been geo-tagged either automatically by advanced cameras or manually by the photographers. They constitute a rich resource of information that can serve many applications.

The tourism industry has been around for a long time. The standard practice is as follows: People become interested in a certain place or a certain type of place through information obtained from various sources, e.g., word of mouth, travel logs, a book or movie; they approach a travel advisor to select the places and plan the trips as the travel advisor is the one who has access to the needed information. The availability of massive tagged photos on the web will reshape tourism by empowering the people so they can determine places to visit.

Geographical positioning system (GPS) devices have revolutionized the art and science of tourism. Besides providing navigational services, GPS units store information about recreational places, parks, restaurants, and airports that are useful to make travel decisions on the fly. Popularity of the GPS technology is an ideal example of how our daily lives have become tied to the need for instant location-specific information. From being a stand-alone navigational device in the past, today's GPS has found its way into mobile devices and cameras with inbuilt or attached receivers.

A fast-emerging trend in digital photography and community photo sharing is geo-tagging. Flickr has amassed about 3.2 million photos geo-tagged in the month this manuscript is being written. Geo-tagging is the process of adding geographical identification metadata to various media such as websites or images and is a form of geospatial metadata. It can help users find a wide variety of location-specific information. For example, one can find images taken near a given location by entering latitude and longitude coordinates into a geo-tagging enabled image search engine. Geo-tagging-enabled information services can also potentially be used to find location-based news, websites, or other resources. Capture of geo-coordinates or availability of geographically relevant tags with pictures opens up new data mining possibilities for better recognition, classification, and retrieval of images in personal collections and the Web. The published article of Lyndon Kennedy, Mor Naaman, Shane Ahern, Rahul Nair, and Tye Rattenbury, “How Flickr Helps us Make Sense of the World: Context and Content in Community-Contributed Media Collections”, Proceedings of ACM Multimedia 2007, discussed how geographic context can be used for better image understanding.

The availability of geo-tagged and user-tagged photos can allow tourists to discover interesting travel destinations. In the past, people obtained suggestions for their personal tourism from their friends or travel agencies. Such traditional sources are user-friendly however, they have serious limitations. First, the suggestions from friends are limited to those places they have visited before. It is difficult for the user to gain information from less traveled members of the community. Second, the information from travel agencies is sometime biased since agents tend to recommend businesses they are associated with. Even worse, when users plan their travel by themselves, they often find their knowledge is too limited to produce a satisfying travel experience.

The prevalence of the Internet provides the possibility for users to learn to plan their tourism by themselves. There has been an increasing amount of visual and text information that the user can explore from various websites. However, the Internet information is too overwhelming and the users have to spend a long time finding those that they are interested in. Users desire more efficient ways to find tourism recommendations to save time, money, and efforts.

There are a huge number of geo-tagged images from popular websites such as Flickr and Google Earth. However, there has been no previous work studying how to use them for tourism recommendation. The difficulty lies in several aspects: First, it is not an easy task to understand a user's interests. There is always a semantic gap between the high level semantics and the low level visual features. Second, the huge collection of online geo-tagged images contains many irrelevant samples, whose contents are not relevant to the geographical coordinates. Finally, an efficient tourism recommendation system demands for a fast approach to find the places with geo-tagged images which match the user's interests.

For example, US Patent Application US20070271297 describes an apparatus and method for summarizing (or selecting a representative subset from) a collection of media objects. A method includes selecting a subset of media objects from a collection of geographically-referenced (e.g., via GPS coordinates) media objects based on a pattern of the media objects within a spatial region. The media objects can further be selected based on (or be biased by) various social aspects, temporal aspects, spatial aspects, or combinations thereof relating to the media objects or a user. Another method includes clustering a collection of media objects in a cluster structure having a plurality of subclusters, ranking the media objects of the plurality of subclusters, and selection logic for selecting a subset of the media objects based on the ranking of the media objects. While the aforementioned patent application describes summarization of a collection of geo-referenced pictures to form subsets, there is a need to use tagged photos on the web to provide tourism recommendations, which enable a user to either search by a keyword, or an image example under the premise of “if you like that place, you may also like these places”.

### SUMMARY OF THE INVENTION

In accordance with the present invention, there is a method for recommending places to visit, comprising using a processor to provide the following steps:

a) assembling a collection of images, wherein each image has first and second tags with the first tag corresponding to the location where the image was taken, and the second tag corresponding to subject matter of the image;

b) clustering the images in response to the first tags into a plurality of locations;

c) using the images in each location to produce at least one representative image of the location;

d) using the second tags of images of each location to produce a list of representative keywords for each location;

e) providing a query in the term of an image or subject matter, or both; and

(f) using the query in the form of an image to search among the representative images to recommend a location to visit, or using the query in the form of subject matter to search among the keywords to recommend a location to visit.

Features and advantages of the present invention include an efficient way to provide tourism recommendations, which enable a user to either search by a keyword or an image example.

### BRIEF DESCRIPTION OF THE DRAWINGS

FIG. 1 is a block diagram of a system that will be used to practice an embodiment of the present invention;

FIG. 2 is a diagram of the present invention;

FIG. 3 is a flow chart of the operations performed by the data processing system 110 in FIG. 1;

FIG. 4 is a pictorial of the location distribution of a predetermined database of geo-tagged images, and the associated geo-tagged clusters produced by the present invention;

FIG. 5 is a pictorial illustration of the interface of a preferred embodiment of the present invention; and

FIG. 6 is a list of top destinations for a few example keyword queries.

### DETAILED DESCRIPTION OF THE INVENTION

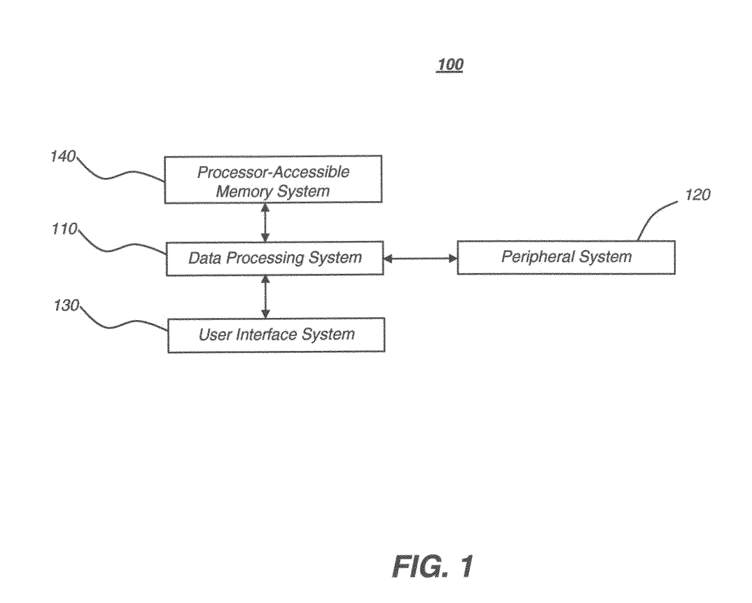

FIG. 1 illustrates a system 100 for recommending places to visit, according to an embodiment of the present invention. The system 100 includes a data processing system 110, a peripheral system 120, a user interface system 130, and a processor-accessible memory system 140. The processor-accessible memory system 140, the peripheral system 120, and the user interface system 130 are communicatively connected to the data processing system 110.

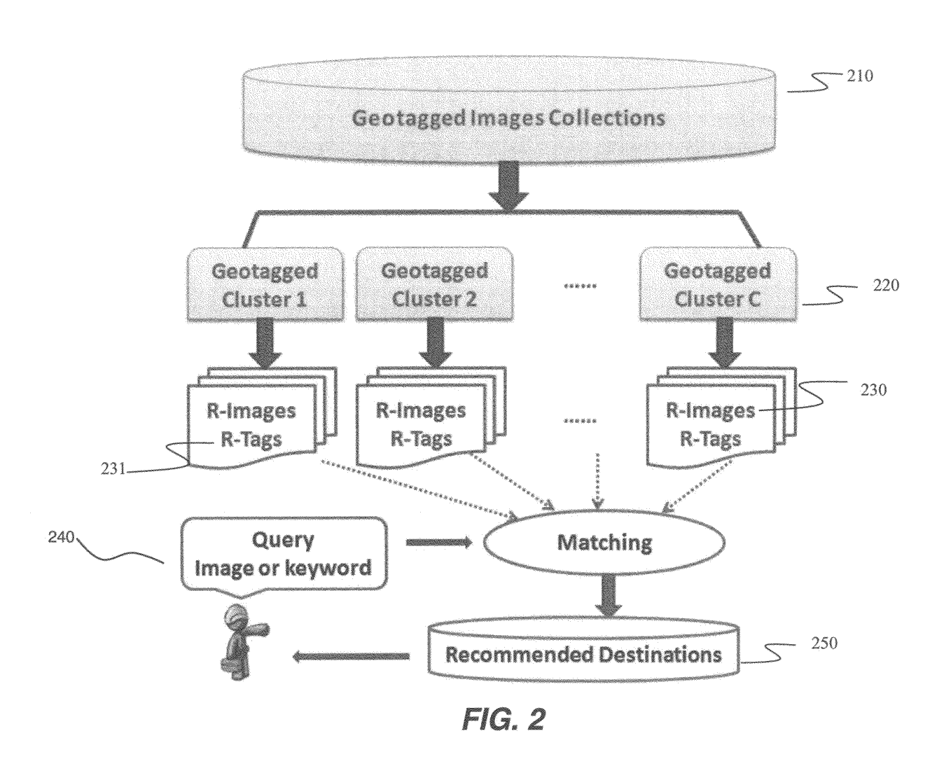

The data processing system 110 includes one or more data processing devices that implement the processes of the various embodiments of the present invention, including the example process of FIG. 2. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device or component thereof for processing data, managing data, or handling data, whether implemented with electrical, magnetic, optical, biological components, or otherwise.

The processor-accessible memory system 140 includes one or more processor-accessible memories configured to store information, including the information needed to execute the processes of the various embodiments of the present invention. The processor-accessible memory system 140 can be a distributed processor-accessible memory system including multiple processor-accessible memories communicatively connected to the data processing system 110 via a plurality of computers or devices. On the other hand, the processor-accessible memory system 140 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data can be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 140 is shown separately from the data processing system 110, one skilled in the art will appreciate that the processor-accessible memory system 140 can be stored completely or partially within the data processing system 110. Further in this regard, although the peripheral system 120 and the user interface system 130 are shown separately from the data processing system 110, one skilled in the art will appreciate that one or both of such systems can be stored completely or partially within the data processing system 110.

The peripheral system 120 can include one or more devices configured to provide digital images to the data processing system 110. For example, the peripheral system 120 can include digital video cameras, cellular phones, regular digital cameras, or other data processors. The data processing system 110, upon receipt of digital content records from a device in the peripheral system 120, can store such digital content records in the processor-accessible memory system 140.

The user interface system 130 can include a mouse, a keyboard, another computer, or any device or combination of devices from which data is input to the data processing system 110. In this regard, although the peripheral system 120 is shown separately from the user interface system 130, the peripheral system 120 can be included as part of the user interface system 130.

The user interface system 130 also can include a display device, a processor-accessible memory, or any device or combination of devices to which data is output by the data processing system 110. In this regard, if the user interface system 130 includes a processor-accessible memory, such memory can be part of the processor-accessible memory system 140 even though the user interface system 130 and the processor-accessible memory system 140 are shown separately in FIG. 1.

The present invention aims to build a system using the above mentioned processor to suggest tourist destinations based on visual matching and minimal user input. A user can provide either a photo of the desired scenery or a keyword describing the place of interest, and the system will look into its database for places that share the visual characteristics. To that end, the present invention first clusters a large-scale geo-tagged web photo collection into groups by location and then finds the representative images for each group. Tourist destination recommendations are produced by comparing the query against the representative tags or representative images under the premise of “if you like that place, you may also like these places”.

Referring to FIG. 2, there is shown a diagram of a tourism recommendation system according to the present invention. The aim is to design a user-friendly and effective system for the task of tourism recommendation. It is believed that the most intuitive way to describe a place is to show the user images so that they know whether or not they would like such a place. Geo-tagged image collections 210 are employed to show the interesting scenes of different places in the world, and produce recommended destinations 250 to users to match their interests.

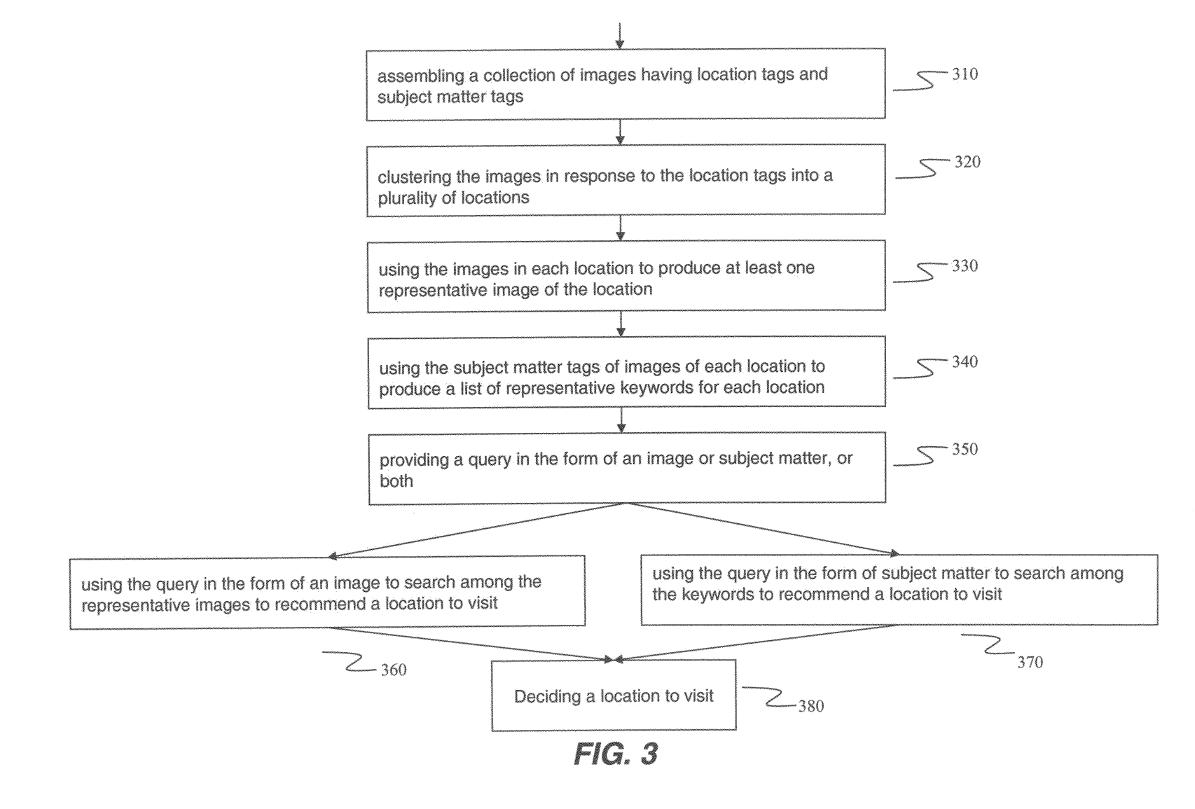

FIG. 3 is a flow chart of the operations performed by the data processing system 110 in FIG. 1 according to the present invention. In the offline step, the present invention first assembles 310 a predetermined large-scale database containing a collection of geo-tagged photos, typically more than one million images that were taken around the world. Such images contain associated location tags (or geo-tags) and subject matter tags. Next, an efficient clustering algorithm 320 is used to divide the world into a plurality of geographical locations, in response to not only the geographical coordinates but also the distributions of geo-tagged images around the world. Referring to FIGS. 2 and 3, for each geo-tagged cluster 220 (loosely corresponds to a region where tourism photos are concentrated), one or a plurality of most representative images (called R-Images) 230 and tags (called R-Tags) 231 are produced to characterize this cluster (location), in steps 330 and 340, respectively. In the online step, a user provides in step 350—a query 240, in the form of either a key word (subject matter) or an image, or both, to describe their interests and intentions. If a query image is provided, the system then uses the query in the form of an image to search 360 among the representative images to recommend a location to visit. If a query keyword is provided, the system then uses the query in the form of subject matter to search 370 among the keywords to recommend a location to visit. A place to visit can be decided in step 380 by a user using either or both search options, either in one pass or through multiple iterations. The corresponding geographical regions are presented as the recommended destinations and further information can be provided for planning the trip.

In one embodiment of the present invention, over 1 million geo-tagged images with GPS records from Flickr. The GPS location for each image is represented by a two-dimensional vector of latitude and longitude. Each image is also associated with user-provided tags, of which the number varies from zero to over ten.

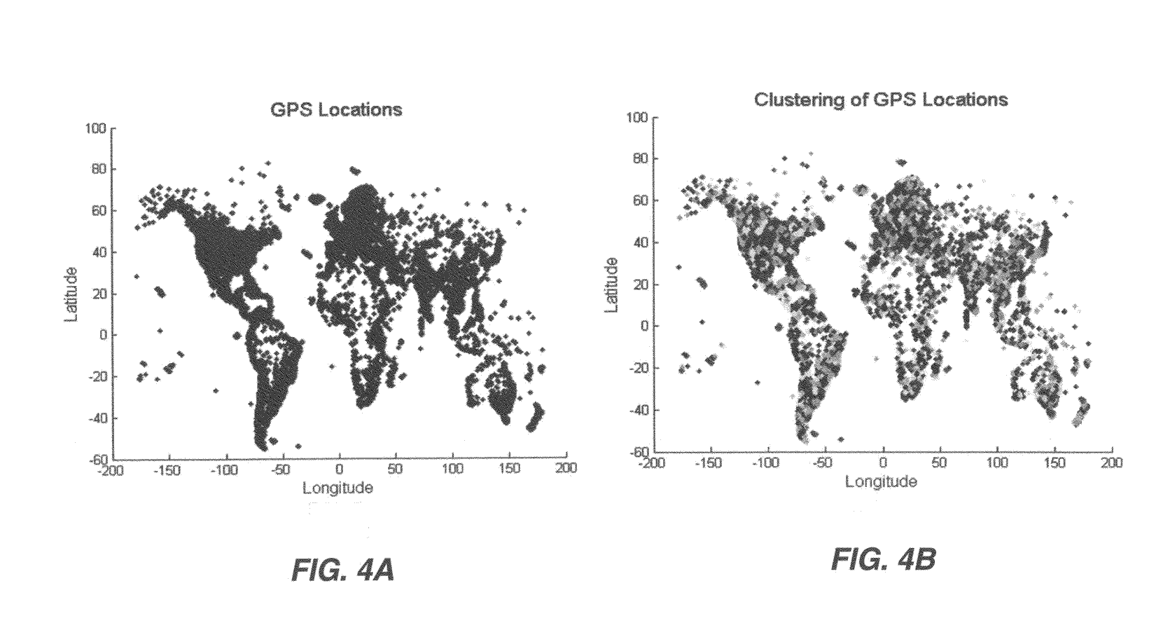

FIG. 4 A shows the distribution of GPS locations for the entire world. It can be seen that geo-tagged locations are not evenly distributed. The image density at a location is related to the potential for that location to be of photographic interest to a tourist. FIG. 4B shows the geo-clustering of geo-tagged images, where clusters are marked with different colors.

To cluster the geo-tagged photos, the mean shift algorithm (see K. Fukunaga and L. Hostetler, “The estimation of the gradient of a density function, with applications in pattern recognition”, IEEE Transactions on Information Theory, 21(1):32-40, 1975.) is applied to the GPS coordinates of all the geo-tagged photos in the predetermined database. Mean shift clustering is a nonparametric method that does not require the specification of the number of clusters, which is generally unknown, and does not assume the shape of the clusters. Starting from a given sample x, Mean shift looks for the vector

$$m ( x ) = \frac{{\sum }_{i} {x}_{i} {g}_{i}}{{\sum }_{i} {g}_{i}} \qquad ( 1 )$$

where gi is the local kernel density function in the form of gᵢ=g(∥(x−xᵢ)/h∥2), where g should be a nonnegative, nonincreasing, and piecewise continuous function.

The most expensive operation of the mean shift method is finding the closest neighbors of a point in the space. In a preferred embodiment of the present invention, the kernel function g is formulated as a flat kernel

$$g ( x ) = \{ \begin{matrix}1 & if \vert x \vert \leq 1 \\ 0 & if \vert x \vert > 1\end{matrix}$$

It is easy to determine that gᵢ !=0 if and only if ∥x−xᵢ∥2<h². Since each x represents GPS coordinate in R², the necessary condition for gᵢ !=0 is:

|x(1)−xᵢ(1)|≦h, |x(2)−xᵢ(2)|≦h (2)

With Equation (2), we can search for the closest neighbors of a sample effectively and speed up the clustering process. Algorithm 1 describes the clustering procedure according to a preferred embodiment of the present invention. The Algorithm 1 shown below works very efficiently with low dimensional data. For our dataset of more than 1.1 millions of images, the clustering procedure takes less than 10 minutes. Any of a plurality of clustering methods can be used for the current invention. The clustering methods disclosed here should not be construed to limit the invention.

Algorithm 1: Mean-shift based GPS Clustering

| Input: GPS coordinates x = {xₗ}, where xₗ is a two dimensional | |
|---|---|
| | vector denoting longitude and latitude. |
| 1: | Initialize center set c = 0, and non-visited set u = x. |
| 2: | for each xₗ ε ∪ do |
| 3: | Set x = xₗ, v = {xₗ} |
| 4: | do |
| 5: | Find x's neighborhood set {xⱼ} using (2). |
| 6: | Compute the vector m(x) using (1). |
| 7: | Update x = m(x) and v = v ∪{xⱼ}. |
| 8: | until x converge. |
| 9: | Update c = c∪x and u = u − v |
| 10: | end for |

Output: The set of cluster centers c and the corresponding

samples in each cluster.

The next step is to find the representative samples in each geo-tagged cluster. The present invention considers two kinds of representatives, images and tags, which are named as R-Images and R-Tags, respectively. The user tags associated with each image are exploited to find R-tags. In particular, the occurrence of each tag in each cluster is computed, and the representative tags are chosen as the ones with occurrence larger than a pre-determined threshold (for example, 10).

On the other hand, it is a non-trivial task to find the R-images. The affinity propagation method (see B. Frey and a Dueck, “Clustering by passing messages between data points”. Science, 315(5814):972, 2007.) is employed for this task. Given N image in a geo-tagged cluster, the similarity between images i and k is denoted as s(i, k). In our experiments, the similarity is measured by a Gaussian function

s(i,k)=exp(−∥fᵢ−fₖ∥²/δ)

where f denotes the image features or visual features that are extracted from each image, e.g., GIST (see A. Oliva and A. Torralba, “Modeling the shape of the scene: a holistic representation of the spatial envelope”. IJCV, 42(3):145-175, 2001.) or the well-known color histogram. The parameter δ is set to the estimated variance of the given visual features. Using affinity propagation, one looks for exemplar ci for each image i, where cᵢ=1, . . . , N. Here cᵢ=i1 means the image i is a representative image since its exemplar is itself. Affinity propagation considers all data points as potential exemplars and iteratively exchanges messages between data points until it finds a good solution with a set of exemplars. There are two kinds of messages: responsibility r(i, k) stands for the confidence of image i belongs to a cluster k, while availability a(k, i) denotes the possibility of image k being the exemplar of image i. The affinity propagation algorithm updates r(i, k) and a(k, i) iteratively until converge. Finally, the exemplar for image i is selected by pi=argmaxₖ [r(i, k)+a(k, i)].

Although affinity propagation finds the potential representative images in each geo-tagged cluster, not all these images are meaningful. To remove the insignificant images e.g., those without popular scenery contents, we count the popularity Nₚ for each potential representative images p, i.e., the number of images which choose p as their exemplar. When Nₚ is small, it means p is probably an outlier. We only choose R-Images when Nₚ is large enough.

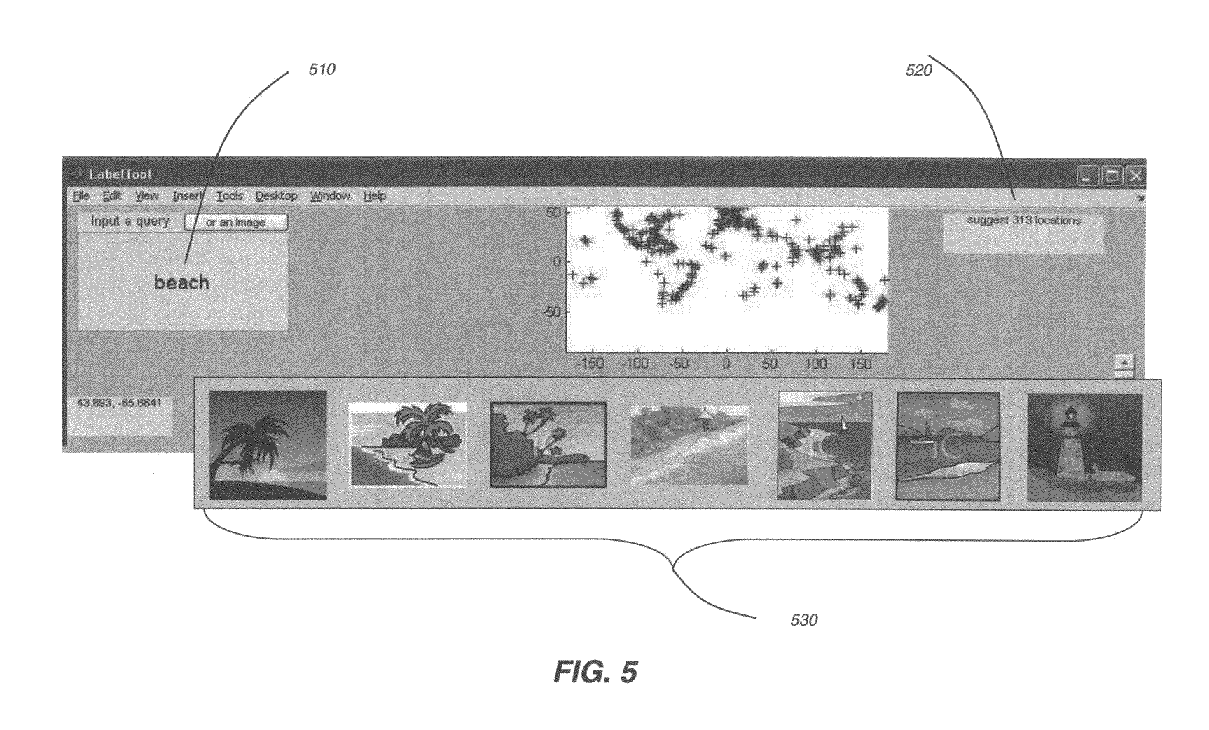

The tourism recommendation system of the present invention is based on the representative tags and images, i.e., R-Tags and R-Images, with their corresponding GPS locations. An example system interface is shown in FIG. 5. The user can choose to provide a query in the form of either a keyword or an image 510, the system searches the database and matches the representative images and tags with the given query. For a keyword query, a plurality of suggested or recommended geo-tagged locations 520 is chosen if the representative tags contain the query keyword. For an image query, the suggested or recommended geo-tagged locations 520 are ranked according to the similarity between the query images and the representative images of different clusters and the top locations are presented to the user. In either case, the plurality of recommended places are shown on a map, and a plurality of representative images 530 of a location are displayed to the user to provide a visual summary of the location once a location is chosen. Alternatively, randomly selected images can be shown for each location.

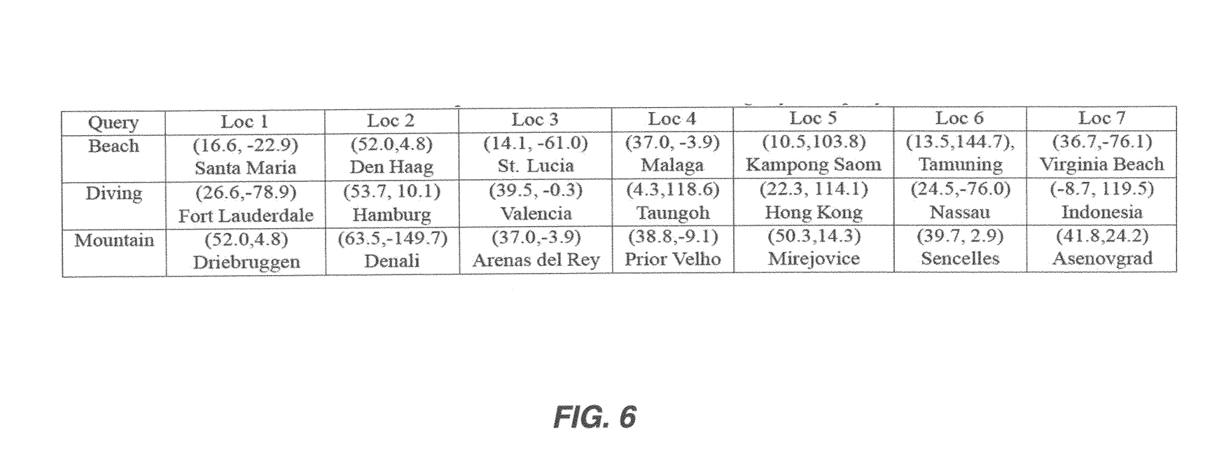

FIG. 6 lists examples of the top destinations retrieved using keywords, including “beach”, “diving”, and “mountain”. The top seven locations for each query are shown, although the total recommendations can be as many as a hundred. Since it is not easy to interpret GPS coordinates directly, the closest city names are provided. The inventive travel recommendation system can provide a wide range of destinations, therefore it is more appealing in the variety than those from friends or travel agencies and potentially more powerful.

The advantages of the present invention are two-fold. First, it makes use of geo-tagged and user-tagged photos available on the Internet as the basis for tourism recommendation. Second, representative images for each photo-rich location are selected as a concise visual characterization of the place and presented for tourism recommendation. Finally, a flexible interface is provided to allow the user to use either keywords or query images to describe their interests. The combination of two kinds of queries provides a higher chance for the user to find a desired place to visit.

The various embodiments described above are provided by way of illustration only and should not be construed to limit the invention. Those skilled in the art will readily recognize various modifications and changes that can be made to the present invention without following the example embodiments and applications illustrated and described herein, and without departing from the true spirit and scope of the present invention, which is set forth in the following claims.

### PARTS LIST

100 All elements of a processor
110 Data processing system
120 Peripheral system
130 User interface system
140 Processor-accessible memory system
210 Geo-tagged image collections
220 Geotagged clusters
230 Representative image
231 Representative tag
240 Query (a image or keyword)
250 Recommended destinations
310 Step of assembling a collection of images having location tags and subject matter tags
320 Step of clustering the images in response to the location tags into a plurality of locations
330 Step of using the images in each location to produce at least one representative image of the location
340 Step of using the subject matter tags of images of each location to produce a list of representative keywords for each location
350 Step of providing a query in the form of an image or subject matter, or both
360 Step of using the query in the form of an image to search among the representative images to recommend a location to visit
370 Step of using the query in the form of subject matter to search among the keywords to recommend a location to visit
380 A decided place to visit
510 User query (keyword or image)
520 Recommended or suggested geo-tagged locations
530 Displayed representative images

1. A method for recommending places to visit, comprising using a processor to provide the following steps:
a) assembling a collection of images, wherein each image has first and second tags with the first tag corresponding to the location where the image was taken, and the second tag corresponding to subject matter of the image;
b) clustering the images in response to the first tags into a plurality of locations;
c) using the images in each location to produce at least one representative image of the location;
d) using the second tags of images of each location to produce a list of representative keywords for each location;
e) providing a query in the form of an image or subject matter, or both; and
f) using the query in the form of an image to search among the representative images to recommend a location to visit, or using the query in the form of subject matter to search among the keywords to recommend a location to visit.

2. The method of claim 1 wherein the first tag includes longitude and latitude information of a location, and the step b) includes:
i) using the longitude and latitude for each location as features; and
ii) applying a mean shift clustering algorithm on the features to cluster the images into a plurality of locations.

3. The method of claim 1 wherein the step c) includes:
i) extracting visual features from the images in each location;
ii) clustering based on the extracted visual features of the images in each location into a plurality of groups wherein each group includes visually similar images; and
iii) producing a representative image for each group of visually similar images.

4. The method of claim 1 wherein step f) includes providing a plurality of recommended locations, and one or more images corresponding to each recommended location.

5. The method of claim 4 wherein the one or more images corresponding to each recommended location are representative images, or selected from the corresponding image clusters.

6. The method of claim 4 further including:
g) providing a map indicating the plurality of recommended locations.
